(19) United States
(12) Patent Application Publication
(10) Pub. No.: US 2014/0192079 A1
(43) Pub. Date: Jul. 10, 2014

(54) ADAPTIVE TEMPORAL DITHER SCHEME FOR DISPLAY DEVICES

(71) Applicant: QUALCOMM MEMS TECHNOLOGIES, INC., San Diego, CA (US)

(72) Inventors: Jeho Lee, Palo Alto, CA (US); Manu Parmar, Sunnyvale, CA (US); Nao S. Chuei, San Mateo, CA (US); Koorosh Aflatooni, Cupertino, CA (US); Alan G. Lewis, Sunnyvale, CA (US); Clarence Chui, San Jose, CA (US)

(73) Assignee: QUALCOMM MEMS TECHNOLOGIES, INC., San Diego, CA (US)

(21) Appl. No.: 13/734,704

(22) Filed: Jan. 4, 2013

(51) Int. Cl. G09G 5/02

(52) U.S. Cl. CPC G09G 5/02
USPC 345/597

(57) ABSTRACT

This disclosure provides systems, methods and apparatus, including computer programs encoded on computer storage media, for displaying high resolution images using an adaptive temporal dithering scheme on display devices having two or more color planes. The adaptive temporal dithering scheme includes identifying the dither visibility of an image to be displayed by the color planes and adaptively applying temporal dithering to the color plane having the highest dither visibility. In one aspect, temporal dithering can be adaptively applied between two different color planes on a frame-by-frame basis based at least partly on the dither visibility of the image content.

### TECHNICAL FIELD

This disclosure relates to the field of temporal dithering of color channels in displays and more particularly to electromechanical systems based display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Digital images are commonly quantized into a plurality of grayscale or color levels for printing or displaying the digital images on a medium with limited tonescale resolution. Various techniques have been developed to reduce errors associated with quantization and to create the illusion of continuous-tone imagery in printed and displayed images.

Halftoning techniques have been developed to create the illusion of continuous-tone images on display devices that display a finite number of tones (for example, colors). For example, halftoning techniques can be used to display or print high resolution images (e.g. images having 24 bits per pixel, 8 bits per color channel) on a medium (e.g. a display device) having lower resolution (e.g. 2 or 4 bits per color channel). Examples of common halftoning techniques include spatial or temporal dithering and error diffusion.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus comprising a display device having a plurality of display pixels and a processor configured to communicate with the display device. Each display pixel is configured to display a plurality of colors in a color space associated with the display device. In various implementations, a color in the color space of the display device can represent tone, grayscale, hue, chroma, saturation, brightness, lightness, luminance, correlated color temperature, dominant wavelength, or a coordinate in the color space. The processor is configured to process an image data including a plurality of image pixels for display by the display device. The processor is further configured to map the image data to the plurality of display pixels to provide data associated with each color plane in the color space associated with the display device. The color plane data includes a color value for each display pixel in the display device. The processor is configured to identify display pixels having spatial frequencies below a threshold for each color plane. For each of the identified display pixels in each color plane, the processor is configured to calculate a dither visibility score based at least in part on comparison of the color value for the display pixel and a dither visibility function for the color plane and determine an accumulated dither visibility score for each color plane. The processor is configured to apply temporal dither to a subset of the plurality of color planes based on the determined accumulated dither visibility scores. In various implementations, the temporal dither can include a Floyd-Steinberg dither.

In some implementations, the processor can be configured to apply temporal dither to the color plane having the highest dither. In various implementations, the processor is configured to apply temporal dither to the color plane determined to have the second-highest accumulated temporal dither visibility score. In various implementations, the temporal dither applied to the color plane determined to have the second-highest accumulated dither visibility score is less than the temporal dither applied to color plane determined to have the highest accumulated dither visibility score. In some implementations, the temporal dither applied to the color plane determined to have the highest accumulated dither visibility score can be a 3-bit temporal dither, and the temporal dither applied to the color plane determined to have the second-highest accumulated dither visibility score can be a 1-bit temporal dither. In various implementations, the processor can be configured to apply temporal dither to only the color plane determined to have the highest accumulated dither visibility score. In various implementations, the dither visibility function can be stored as a look-up table (LUT). In some implementations, the plurality of color planes can include at least two color planes selected from the group consisting of a red color plane, a green color plane, and a blue color plane. In various implementations, the plurality of color planes can include a first color plane configured to display a first hue of a color and a second color plane configured to display a second hue of the color, the first hue different from the second hue. In various implementations, the display device can have a frame refresh rate less than 60 Hz. In various implementations, the display device can be a reflective display device. In some implementations, each display pixel can include at least three or four subpixels. In various implementations, each subpixel can include a movable mirror element. In some implementations, the movable mirror elements of two different subpixels in each pixel can have different reflective areas. In various implementations, each subpixel can be configured to display two bit color in the color space associated with the display device.

Another innovative aspect of the subject matter described in this disclosure can be implemented in an apparatus comprising a means for displaying image data including a plurality of image pixels and a means for processing the image data for display by the displaying means. The displaying means have a plurality of display pixels that are configured to display a plurality of colors in a color space associated with the displaying means. The processing means is configured to map the image data to the plurality of display pixels to provide data associated with each color plane in the color space associated with the displaying means. The color plane data includes a color value for each display pixel in the displaying means. The processing means is configured to identify display pixels having spatial frequencies below a threshold for each color plane. For each of the identified display pixels in each color plane, the processing means is configured to calculate a dither visibility score based at least in part on comparison of the color value for the display pixel and a dither visibility function for the color plane and determine an accumulated dither visibility score for each color plane. The processing means is configured to apply temporal dither to a subset of the plurality of color planes based on the determined accumulated dither visibility scores. In various implementations, the displaying means can include a reflective display device. In various implementations, the processing means can include a processor in communication with the displaying means. In various implementations, the processing means can include at least one of an accumulator and a comparator.

Another innovative aspect of the subject matter described in this disclosure can be implemented in a method for adaptively applying temporal dithering to display an input image having reduced dither visibility on a display device having a plurality of display pixels. Each display pixel is configured to display a plurality of colors in a color space associated with the display device. The method is performed in its entirety by a physical computing device. The method comprises mapping the input image to the plurality of display pixels to provide data associated with each color plane data for each color in the color space associated with the display device. The color plane data includes a color value for each display pixel in the display device. The method comprises identifying display pixels having spatial frequencies below a threshold for each color plane. The method further comprises calculating a dither visibility score for each of the identified pixels in each color plane. The dither visibility score is calculated based at least in part on comparison of the color value for the display pixel and a dither visibility function for the color plane. The method comprises determining an accumulated dither visibility score for each color plane and applying temporal dither to a subset of the plurality of color planes based on the determined accumulated dither visibility scores.

Another innovative aspect of the subject matter described in this disclosure can be implemented in a non-transitory computer storage medium comprising instructions that when executed by a processor cause the processor to perform a method for adaptively applying temporal dithering to display an input image having reduced dither visibility on a display device having a plurality of display pixels. Each display pixel is configured to display a plurality of colors in a color space associated with the display device. The method comprises mapping the input image to the plurality of display pixels to provide data associated with each color plane data for each color in the color space associated with the display device. The color plane data includes a color value for each display pixel in the display device. The method comprises identifying display pixels having spatial frequencies below a threshold for each color plane. The method further comprises calculating a dither visibility score for each of the identified pixels in each color plane. The dither visibility score is calculated based at least in part on comparison of the color value for the display pixel and a dither visibility function for the color plane. The method comprises determining an accumulated dither visibility score for each color plane and applying temporal dither to a subset of the plurality of color planes based on the determined accumulated dither visibility scores.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5 is an implementation of a display device having four color channel pixel architecture.

FIG. 6 illustrates an example of dither visibility with respect to input tone when an image having a continuous tone is quantized using 3 quantization levels.

FIG. 7 illustrates a flowchart of an implementation of an adaptive temporal dither method for a display device including a plurality of pixels that provide color plane data for each color in a color space associated with the display device.

FIG. 8A illustrates a flowchart that describes an implementation of a method of adaptive temporal dithering.

FIG. 8B illustrates a flowchart that describes an implementation of a method to determine an accumulated dither visibility score for a color plane.

FIGS. 9A and 9B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The systems and methods described herein can be used to display high resolution color images (e.g. images having 24 bits per pixel, 8 bits per color channel) on a display device including a plurality of display pixels having lower color resolution (for example, 2 or 4 bits per color channel). Each display pixel in the display device can display a color in a color space associated with the display device with a color resolution associated with a number of bits (for example, 2 or 4 bits). To display high resolution color images (for example, with 8 bits per color channel or 256 color levels per color channel) on a display device having a lower color resolution, a method referred to as color quantization can be used to reduce the number of possible distinct color levels per channel (for example, 256 color levels per channel) in the image to the number of possible distinct color levels that can be produced by the display device (for example, 4 or 16 color levels per channel).

The color quantization process can be associated with a quantization error which can result in visual artifacts that can degrade the visual quality of the displayed image. For example, color quantized images can appear speckled or grainy. Techniques such as dithering can be used to enhance the visual quality of the displayed image. One form of dithering that can be used to enhance the visual quality of the displayed image is temporal dithering. In temporal dithering, a display pixel can be configured to display different color values from the display color space at different times to create the illusion of color depth.

Systems and methods that can apply adaptive temporal dither based on the content of a given input image as described herein can more fully exploit the benefit of applying temporal dither for a given input image. An implementation of an adaptive temporal dithering scheme includes identifying smooth portions of the display image. In various implementations, this can be achieved by identifying display pixels that are associated with low spatial frequencies in each color plane. A dither visibility score can be computed for each of the identified display pixels. The dither visibility score can quantitatively represent an amount of visible dither noise in the smooth portions of the image for each color plane. An accumulated dither visibility score can be computed for each color plane by aggregating the dither visibility score for the identified display pixels in the color plane. A higher accumulated dither visibility score is generally associated with higher visibility of dither artifacts (for example, graininess or noisiness). Thus, temporal dither can be applied adaptively based on the image content. For instance, temporal dither can be applied to the color plane that is determined to have the highest accumulated dither visibility score, which may reduce the visibility of dither artifacts.

Particular implementations of the subject matter described in this disclosure can be implemented to realize one or more of the following potential advantages. It is possible to display high resolution continuous-tone digital images on display devices having low native resolution that can display a limited number of tones or color levels by using halftoning to render intermediate tones that cannot be natively displayed by the display device. However, the halftoning process trades-off spatial resolution for tone resolution. For example, if the pixel size of the display device is not small enough to be invisible to the human eye, halftone patterns for various tones generally will be visible. For image content that is smooth (or without texture), the halftone pattern can be perceived as dither noise on a solid background. As discussed above, temporal dithering can advantageously reduce the visible dither noise. However, temporal dithering may not reduce the dither noise equally for all portion of the displayed image. For example, temporal dithering can enhance the visual quality of smooth portions of the displayed image to a greater extent than the edges or the portions of the displayed image having high frequency content. Additionally, due to limitations on processor speed, it may not be practical to temporally dither all the color planes displayed by the display device. Thus, applying temporal dither to only those regions of the displayed image and/or only those color planes that have the highest amounts of visible dither noise, as discussed in certain implementations of the adaptive temporal dither scheme described herein, can provide the benefits of temporal dithering while making efficient use of processor speed and other available hardware resources. Accordingly, certain implementations of the adaptive temporal dithering scheme discussed herein can be used to display high resolution continuous tone images on low resolution display devices constrained by processor speeds and other hardware resources with reduced dither visibility.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage Vₒ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

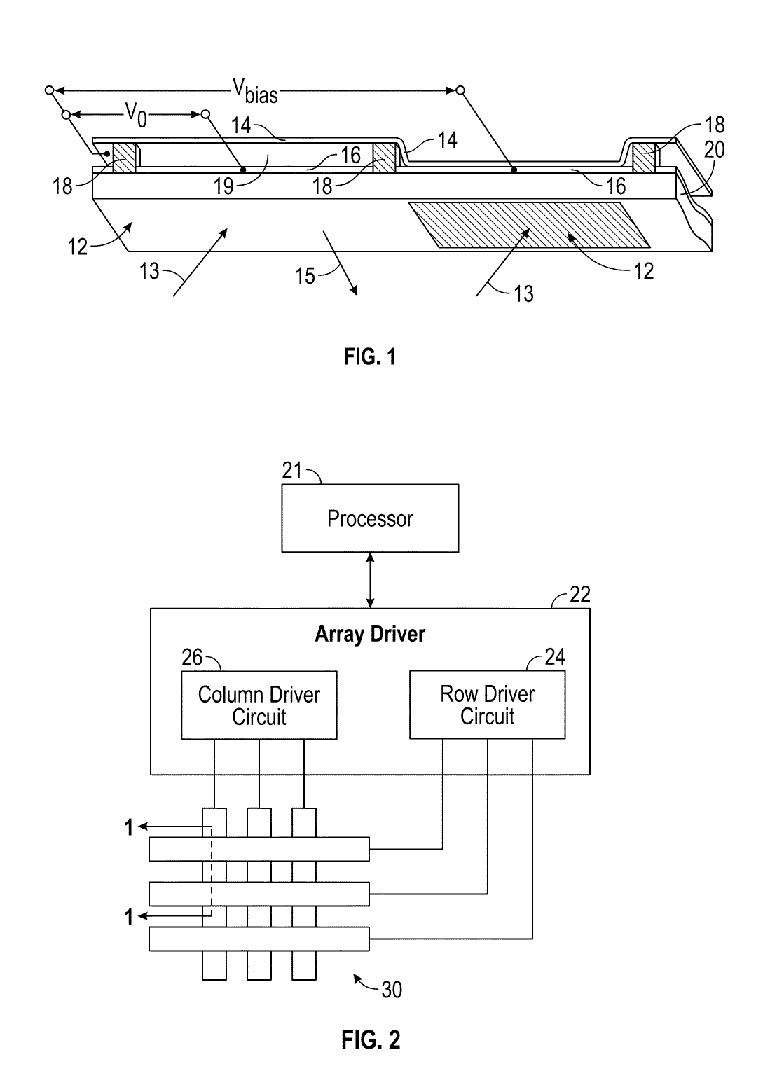

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

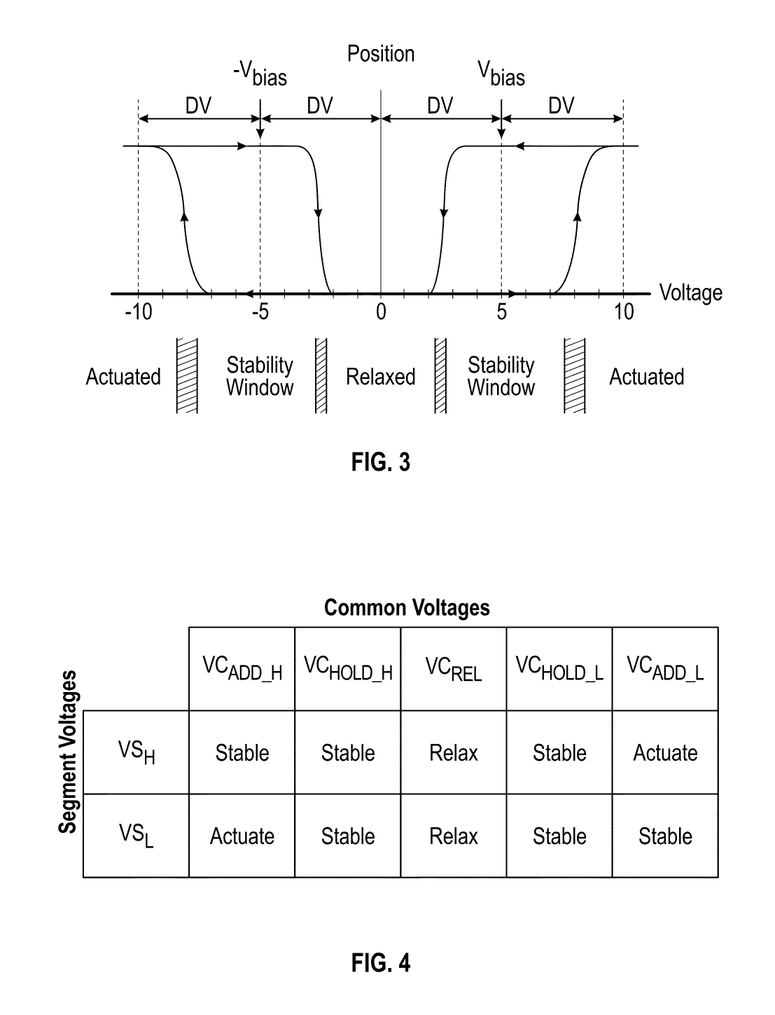

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

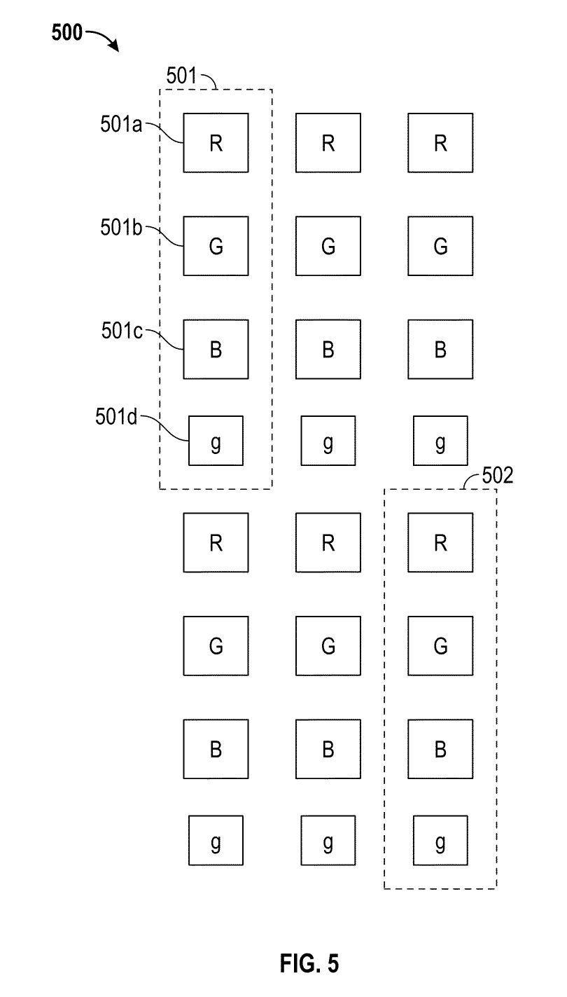

FIG. 5 is an implementation of a display device 500 having four color channel pixel architecture. The display device 500 illustrated in FIG. 5 includes a plurality of display pixels 501 and 502. Each pixel 501 and 502 includes four subpixels 501a, 501b, 501c, and 501d. Each subpixel 501a-501d can be configured to display a different color in a color space associated with the display device. A color in the color space associated with the display device can represent tone, grayscale, hue, chroma, saturation, brightness, lightness, luminance, correlated color temperature, dominant wavelength, or a coordinate in the color space. For example, in the illustrated implementation, the first subpixel 501a is configured to display red (R), the second subpixel 501b is configured to display a first shade or hue of green (G), the third subpixel 501c is configured to display blue (B), and the fourth subpixel 501d is configured to display a second shade or hue of green (g). In various implementations, the second shade or hue of green (g) displayed by the fourth subpixel 501d can be darker or more saturated than the first shade or hue of green (G). In various implementations, the fourth subpixel 501d can have a smaller active area as compared to the active area of the second pixel 501b. For example, in various implementations, a size of the active area of the fourth subpixel 501d can be about one-half, one-third or one-fourth the size of the active area of the second subpixel 501b.

Various implementations of the display device 500 can include a reflective display device. In some such implementations, the subpixels 501a-501d can include a reflective mirror that can be moved between different positions to display black (or no color) or to display one or more colors in the display device color space. The reflective mirror can form a portion of the active area of the subpixel. In various implementations, the subpixels 501a-501d can include interferometric modulators similar to the IMOD display elements 12 discussed above. The display device illustrated in FIG. 5 can be referred to as a display device having a binary weighted green (BWG) pixel architecture. A display device having a BWG pixel architecture including two green subpixels 501b and 501d that are configured to display different shades or hues of green can provide advantages such as an increase in color gamut (as the subpixel 501d having a reduced area can produce a more saturated green) while maintaining a proper level of brightness for the white point (by using the two green subpixels together).

A digital color image includes a plurality of image pixels and each of the plurality of image pixels includes a combination of colors. The color of an image pixel can be represented by coefficients in a coordinate system in a multi-dimensional color space. For example, each image pixel of a digital color image can be represented by a number of coefficients (such as three or four) in a color space (e.g., standard RGB (sRGB) color space, International Commission on Illumination (CIE) XYZ color space, etc.). The coefficients can represent weights or levels for each of the color channels that make up the color space. For example, in various implementations, the coefficients can represent each of the three color channels red (R), green (G), and blue (B) in the sRGB color space. As another example, the coefficients can represent the color channels cyan (C), magenta (M), yellow (Y) and black (K) in a color space that uses CMYK color model. For further discussion of FIG. 5, consider that the input image is a three-dimensional (3D) data array with RGB values at each spatial location. Such an input image can be displayed on a display device similar to the display device 500 illustrated in FIG. 5 by mapping the 3D input image data array onto the plurality of pixels 501 and 502. Mapping the 3D input image array on to the plurality of pixels 501 and 502 includes assigning a value for each pixel in the color space associated with the display device to provide color plane data for each color in the display device color space. Consider a display device including a plurality of display pixels that are configured to display red (R) color, green (G) color and blue (B) color in the display device color space. For such a display device, the plurality of display pixels that display red color collectively provide data for the red (R) color plane. Similarly, the plurality of display pixels that display green color collectively provide data for the green (G) color plane and the plurality of display pixels that display blue color collectively provide data for the blue (B) color plane.

A high-tonescale-resolution color image can have a number of bits, n, representing each color channel making up the image pixel. In various implementations, the number of bits, n, can be, for example, 2, 4, 8, 16 or 24. When a high-tonescale-resolution image (such as an image having 8, 16 or 24 bits per color channel) is displayed on a display device having lower color resolution (for example, 2 or 4 bits per color channel), each color channel may be quantized to reduce the number of color levels to the number of bits displayable by each color channel. The quantization process can be associated with a quantization error. A halftone pattern can be used to provide intermediate color levels and create the illusion of continuous tone. If the size of the display pixels is not small enough to be invisible to the human eye, the quantization error and/or the halftone pattern can be visible and affect the visual quality of the displayed image. For example, the quantized and halftoned images may appear grainy or speckled. Various implementations of a display device having a BWG pixel architecture, such as, the display device 500 illustrated in FIG. 5 can advantageously reduce the visible graininess or speckles (also referred to as ‘dither visibility’) in the displayed image.

In various implementations, temporal dithering can be used to reduce the dither visibility. Temporal dithering refers to a modulation technique to render different pixel values in different time intervals. In temporal dithering, a display pixel can be configured to display different color values from the display color space at different times to create the illusion of color depth. If used, temporal dither can be applied to one, some, or all of the color channels of the display device. Temporal dither algorithms include Floyd-Steinberg dither algorithms. In some implementations of the display device 500, a 7-level temporal dither can be applied to the subpixels 501b that display a first shade or hue of green (G) and/or to the subpixels 501d that display a second shade or hue of green (g). The subpixels that are not temporally dithered can be halftoned with 3-level error diffusion. Although, temporal dithering can reduce dither visibility, it may not do so consistently for different portions of the image. In certain implementations of display devices where each display pixel can be individually controlled, temporal dithering may be performed on a pixel level. In such implementations, each pixel can be individually temporally dithered. In some other implementations of display devices, a group of pixels that display the same color in the display device color space (for example, a color plane or a portion of the color plane) can be collectively temporally dithered. Such a scheme for applying a temporal dither collectively to an entire group of pixels displaying the same color can be useful in reducing the complexity of drivers and processors that are used to control the display pixels. Furthermore, applying a temporal dither collectively to an entire group of pixels displaying the same color can be advantageous in realizing high-speed display devices having fast refresh rate.

Temporal dithering can be more beneficial in a display device having a fast refresh rate since flickering between sub-frames can be reduced in such a display device. For a majority of human eyes, flicker starts to appear when the frame rate drops below about 60 Hz. Various implementations of the display device 500 illustrated in FIG. 5 may not be capable of providing a high frame rate due to constraints imposed by the display driver. For example, some implementations of the display device 500 can provide a frame rate of up to about 30 Hz. In such implementations, it may not be practical to apply temporal dither to all the color planes provided by subpixels 501a-501d. However, if temporal dither is applied to only a subset of the color planes, such as only one color plane (for example, color plane having a first shade or hue of green (G), color plane having a second shade or hue of green (g)), a refresh rate of 120 Hz per frame can be achieved, in certain implementations, thereby reducing flicker.

Accordingly, implementations of the adaptive temporal dither systems and methods described herein can determine which color plane (or planes) to temporally dither when the refresh rate is too low to temporally dither all color planes. The implementations of the adaptive temporal dither systems and methods described herein can advantageously apply temporal dither to an entire or a portion of color plane when it may not be practical to apply temporal dither to each individual display pixel. In various implementations, temporal dither can be applied to one, two, or all the color planes of the display device. In various implementations, temporal dither can be applied to a portion of one, two, or all the color planes of the display device. Additionally, implementations of the adaptive temporal dither systems and methods discussed herein can switch the color plane to which temporal dithering is applied (for example between a color plane having a first shade or hue of green (G) and a color plane having a second shade or hue of green (g)) per image frame, based at least partly on the image content so as to reduce dither visibility consistently for different portions of the image. As such, the adaptive temporal dither systems and methods can more fully exploit the benefit of temporal dither for a given input image. The adaptive temporal dither systems and methods discussed herein can be used for a wide variety of displays and are not limited to the BWG display architecture illustrated in FIG. 5.

The dither visibility can depend at least in part on the input tone and the quantization levels of the display device. Dither visibility can be quantified using models of the human visual system (HVS). Without subscribing to any particular theory, generally the HVS has a low-pass effect, wherein the HVS response falls off rapidly with increasing spatial frequency. The HVS is also generally less sensitive to chrominance than luminance. The HVS response functions can be used to quantify the dither visibility.

Dither visibility can be quantified in many ways. In one method used to quantify dither visibility, x and y are the continuous tone and halftoned patches respectively, and Hy and Hc are the luminance and chrominance responses of the HVS respectively. The dither visibility in each color plane can be calculated by converting the continuous tone and halftoned patches in the color space of the display device to a perceptually linear color space (e.g., the linearized CIELab color space), which can be used as a reference. The components of the linearized CIELab color space are one luminance channel and 2 chrominance channels. The visible error, e, between the continuous tone and the halftoned patches for vectorized versions of x and y can be calculated from the following equation:

$$e ‖ HFC ( [ \begin{matrix}{x}_{R} \\ {x}_{G} \\ {x}_{B}\end{matrix} ] - [ \begin{matrix}{y}_{R} \\ {y}_{G} \\ {y}_{G}\end{matrix} ] ) ‖$$

where H is a block matrix with the HVS luminance and chrominance responses, and C transforms the display device color space values to linearized CIELab space. The matrix F is the discrete Fourier transform matrix and transforms the color space values to frequency space, because the luminance and chrominance responses (H) are in frequency space. In some implementations, the error e can be used to measure the dither visibility. Higher values of dither visibility represent higher errors perceived by the HVS.

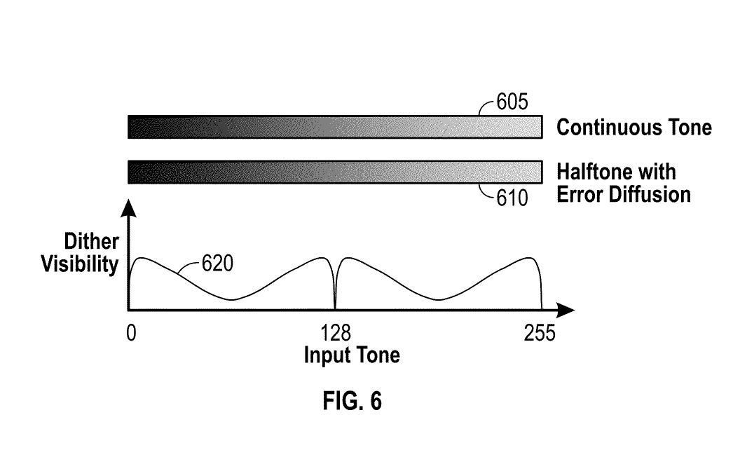

FIG. 6 illustrates an example of the dither visibility with respect to the input tone when an image having a continuous tone is quantized using 3 quantization levels. In FIG. 6, the input tone includes 256 tone levels (from 0 to 255). An upper bar 605 shows the appearance of the continuous tone levels, and a lower bar 610 shows the appearance of the continuous tone levels after halftoning with error diffusion. The graph below the two bars 605, 610 shows the dither visibility 620 as a function of input tone. As observed from FIG. 6, the dither visibility is higher when the spatial dither pattern has lower spatial frequency. In other words, the dither visibility is higher when the input image has a smooth texture. When quantized using 3 quantization levels, the dither visibility is zero ‘0’ for quantized tone levels 0, 128 and 255 as observed from the graph of the dither visibility 620 as a function of input tone indicating that these tone levels can be represented exactly by the display device. In various implementations, a display device can store the dither visibility with respect to input tone in a look-up-table (LUT) (or other data structure). In other implementations, the dither visibility can be represented mathematically (for example, using a polynomial or spline fit).

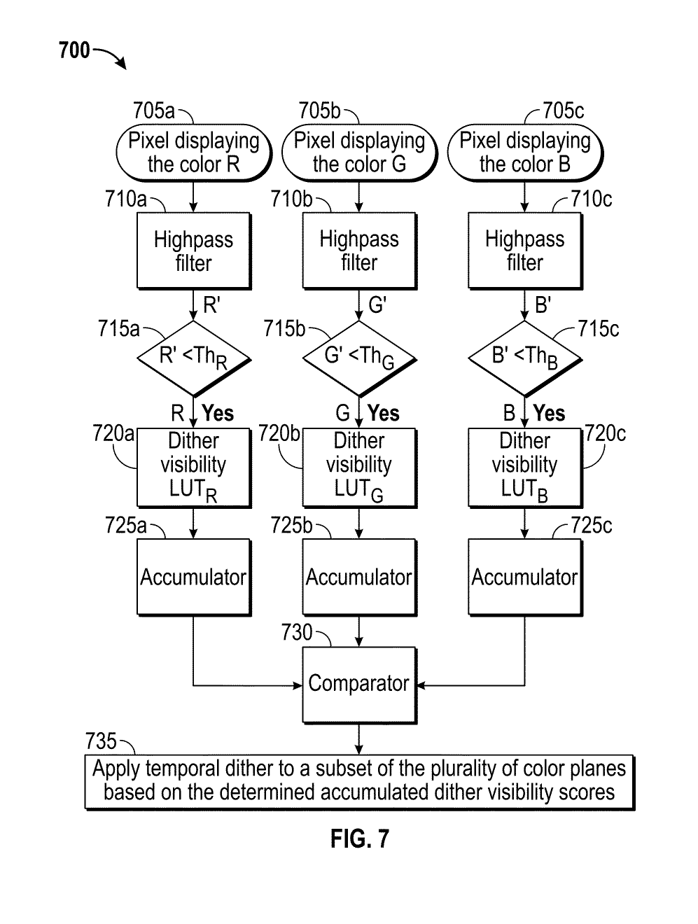

FIG. 7 illustrates a flowchart 700 of an implementation of an adaptive temporal dither method for a display device including a plurality of pixels that provide color plane data for each color in a color space associated with the display device. In various implementations, the display device can include an RGB display device or a BWG display device as described in FIG. 5. In the illustrated implementation, a high-pass filter is applied to the plurality of pixels in each color plane (for example, red (R), green (G) and blue (B) color planes in RGB devices or red (R), first shade or hue of green (G), blue (B), and second shade or hue of green (g) color planes in the BWG display device of FIG. 5), as shown in blocks 705a-705c and blocks 710a-710c. Portions of the image with rapid tone changes where dither is not particularly visible can be excluded from the high-pass filter in certain implementations. To identify the one or more color planes to apply temporal dither, the following operations can be performed:

For each color plane:
a. The high-pass filtered color value (for example, R′, G′, B′ or R′, G′, B′, g′) is compared against a threshold value ‘Th_{R}’, ‘Th_{G}’, or ‘Th_{B}’, as shown in blocks 715a-715c. In various implementations, the threshold value ‘Th_{R}’, ‘Th_{G}’, or ‘Th_{B}’ can be between about 1% and about 40% of the maximum high-pass filtered value. In various implementations, the threshold values ‘Th_{R}’, ‘Th_{G}’, and ‘Th_{B}’ can be equal to each other. In other implementations, two of the threshold values ‘Th_{R}’, ‘Th_{G}’, and ‘Th_{B}’ can be equal to each other. In some implementations, the threshold values ‘Th_{R}’, ‘Th_{G}’, and ‘Th_{B}’ can be different from each other.
b. If the magnitude of the high-pass filtered color value (for example, R′, G′, B′ or R′, G′, B′, g′) is less than the threshold value ‘Th_{R}’, ‘Th_{G}’, or ‘Th_{B}’, then it is likely the pixel is in a smooth region of the image, where dither artifacts may be visible. A dither visibility score is computed for the input non-high-pass filtered color value, as shown in blocks 720a-720c. The dither visibility score for the input non-high-pass filtered color value maybe computed using the dither visibility function shown in FIG. 7, which can be obtained, for example, by accessing a dither visibility LUT. In various implementations, the dither visibility LUT can be different for different color planes. For example, the dither visibility LUT_{G} for the color plane G may be different from the dither visibility LUT_{R} for the color plane R.
c. The dither visibility scores for all the image pixels having low spatial frequency in a frame are accumulated in an accumulator, as shown in blocks 725a-725c.

The accumulated dither visibility score for each color plane that is accumulated in the accumulator can be compared using a comparator, as shown in block 730, and the color plane with the highest dither visibility score can be identified. In various implementations, temporal dither can be applied to a subset of the plurality of color planes based on the determined accumulated dither visibility scores as shown in block 735. As an example, in some implementations, temporal dither can be applied to the color plane with the highest accumulated dither visibility scores. For example, if the color plane G has a higher accumulated dither visibility score than either the R or B color planes, temporal dither is applied to the G color plane. Although, the method illustrated in the flowchart 700 is for the case of three color planes R, G, and B, in other implementations, the method can be applied to two color planes (for example, color plane G and color plane g) or to four or more color planes.

If the device refresh rate can support temporal dither of additional color channels, then temporal dither can be additionally applied to the color plane having the second highest accumulated dither visibility score, and so forth. In some implementations, the amount of temporal dither applied to the two color planes can be the same. In other implementations, the amount of temporal dither applied to the two color planes can be different. For example, in some implementations, a higher temporal dither (for example, a 3-bit temporal dither) can be applied to the color plane having the highest accumulated dither visibility score and a lower temporal dither (for example, a 1-bit temporal dither) can be applied to the color plane having the second highest accumulated dither visibility score. In various implementations, temporal dithering can be adaptively applied between two different color planes (for example, a color plane having the highest and the second highest dither visibility score) on a frame-by-frame basis based on the image content. For example, in a display device having the four color channel BWG pixel architecture described in FIG. 5, the color plane to which temporal dither is applied can be switched between the color plane G and the color plane g on a frame-by-frame basis based on image content to enhance the visual quality of the displayed image.

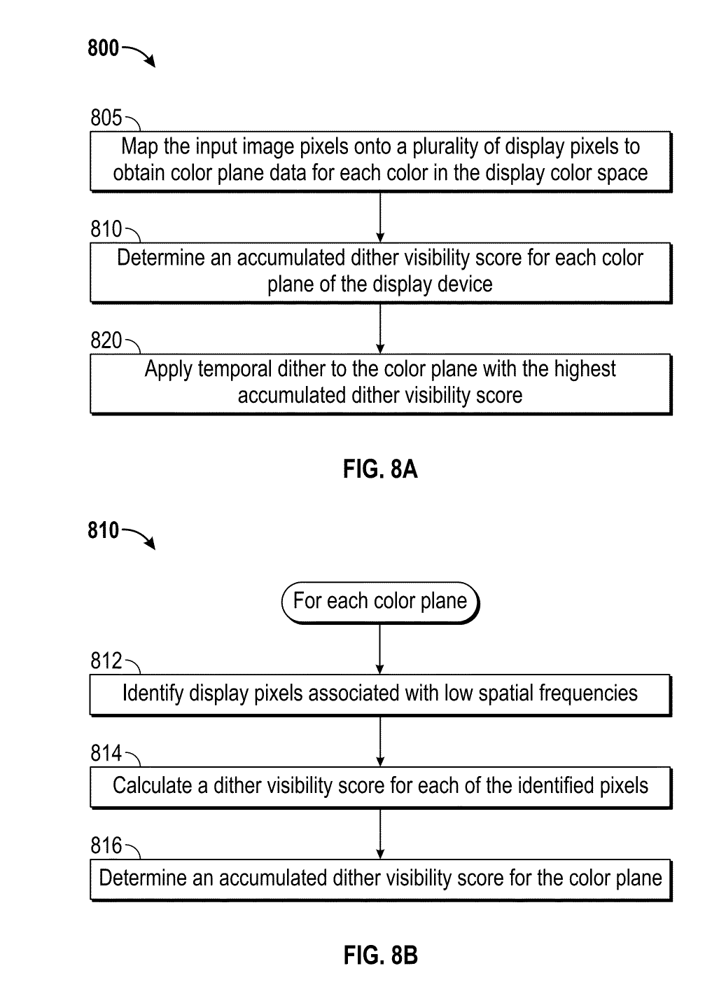

FIG. 8A illustrates a flowchart 800 that describes an implementation of a method of adaptive temporal dithering. The method 800 includes, at block 805, mapping the input image pixels onto a plurality of display pixels to obtain color plane data for each color in the display color space. As discussed above, mapping the input image pixels onto the plurality of display pixels includes assigning a value for each display pixel in the display color space. The method 800 further includes determining an accumulated dither visibility score for each color plane of the display device, as shown in block 805. An example of a method of determining an accumulated dither visibility score for each color plane of the display device is discussed in detail with reference to FIG. 8B. The method 800 further includes temporally dithering the color plane associated with the highest accumulated dither visibility score, as shown in block 820.

FIG. 8B illustrates a flowchart 810 that describes an implementation of a method to determine an accumulated dither visibility score for a color plane. The method 810 includes, at block 812, identifying display pixels associated with smooth regions of the image (for example, regions associated with low spatial frequencies in the color plane data). The method 810 further includes calculating a dither visibility score for each of the identified pixels with low spatial frequencies, as shown in block 814. The dither visibility score can be based at least in part on comparison of the color value for the display pixel and a dither visibility function for the color plane (for example, the dither visibility function shown in FIG. 6). The method 810 includes determining an accumulated dither visibility score for the color plane, as shown in block 816.

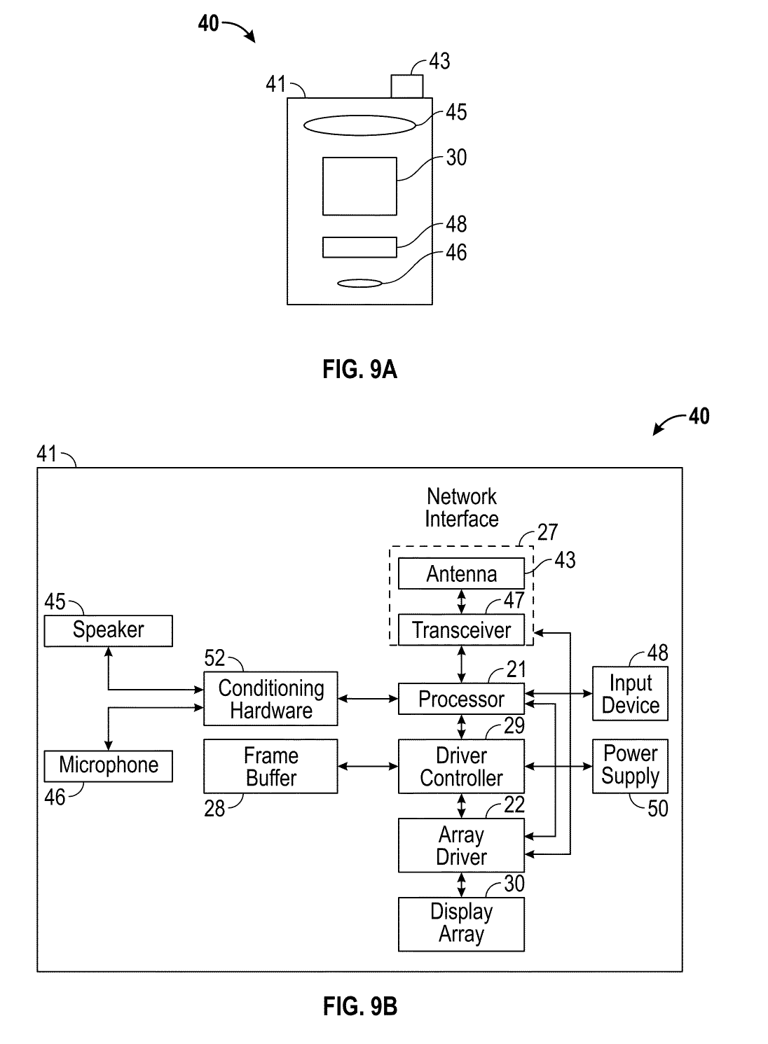

In various implementations, the method illustrated in flowcharts 700, 800 and 810 can be performed by a hardware processor included in the display device (for example, the processor 21 described below with reference to FIG. 9B). To perform the method illustrated in flowcharts 700, 800 and 810, the processor can execute a set of instructions stored in a non-transitory computer storage. The processor can access a computer-readable medium that stores the dither visibility, for example, as an LUT. In various implementations, the processor can include an accumulator and/or a comparator.

FIGS. 9A and 9B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein. In various implementations the display 30 can be a RGB display device or a reflective display device with a four color channel pixel architecture as shown in FIG. 5.

The components of the display device 40 are schematically illustrated in FIG. 9A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. In various implementations, the processor 21 can be configured to implement the methods illustrated by flowcharts 700, 800 and 810. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a display device having a plurality of display pixels, each display pixel configured to display a plurality of colors in a color space associated with the display device; and
a processor configured to communicate with the display device, the processor configured to process image data for display by the display device, the image data including a plurality of image pixels, the processor configured to:
map the image data to the plurality of display pixels to provide data associated with each color plane in the color space associated with the display device, the color plane data including a color value for each display pixel in the display device;
for each color plane:
identify display pixels having spatial frequencies below a threshold,
for each of the identified display pixels, calculate a dither visibility score based at least in part on comparison of the color value for the display pixel and a dither visibility function for the color plane, and
determine an accumulated dither visibility score for the color plane; and
apply temporal dither to a subset of the plurality of color planes based on the determined accumulated dither visibility scores.

2. The apparatus of claim 1, wherein the processor is configured to apply temporal dither to the color plane determined to have the highest accumulated dither visibility score.

3. The apparatus of claim 2, wherein the processor is further configured to apply temporal dither to the color plane determined to have the second-highest accumulated dither visibility score.

4. The apparatus of claim 3, wherein the temporal dither applied to the color plane determined to have the second-highest accumulated dither visibility score is less than the temporal dither applied to color plane determined to have the highest accumulated dither visibility score.

5. The apparatus of claim 4, wherein the temporal dither applied to the color plane determined to have the highest accumulated dither visibility score is a 3-bit temporal dither, and the temporal dither applied to the color plane determined to have the second-highest accumulated dither visibility score is a 1-bit temporal dither.

6. The apparatus of claim 1, wherein the processor is configured to apply temporal dither to only the color plane determined to have the highest accumulated dither visibility score.

7. The apparatus of claim 1, wherein the dither visibility function is stored as a look-up table (LUT).

8. The apparatus of claim 1, wherein the temporal dither includes a Floyd-Steinberg dither.

9. The apparatus of claim 1, wherein the plurality of color planes includes at least two color planes selected from the group consisting of a red color plane, a green color plane, and a blue color plane.

10. The apparatus of claim 1, wherein the plurality of color planes includes a first color plane configured to display a first hue of a color and a second color plane configured to display a second hue of the color, the first hue different from the second hue.

11. The apparatus of claim 1, wherein a color in the color space of the display device represents: tone, grayscale, hue, chroma, saturation, brightness, lightness, luminance, correlated color temperature, dominant wavelength, or a coordinate in the color space.

12. The apparatus of claim 1, wherein the display device has a frame refresh rate less than 60 Hz.

13. The apparatus of claim 1, wherein the display device is a reflective display device.

14. The apparatus of claim 1, wherein each display pixel includes at least three subpixels.

15. The apparatus of claim 14, wherein each subpixel includes a movable mirror element.

16. The apparatus of claim 15, wherein the movable mirror elements of two different subpixels in each pixel have different reflective areas.

17. The apparatus of claim 14, wherein each subpixel is configured to display two bit color in the color space associated with the display device.

18. The apparatus of claim 1, further comprising a memory device that is configured to communicate with the processor.

19. The apparatus of claim 18, further comprising a driver circuit configured to send at least one signal to the display device.

20. The apparatus of claim 19, further comprising a controller configured to send at least a portion of the image data to the driver circuit.

21. The apparatus of claim 1, further comprising an image source module configured to send the image data to the processor.

22. The apparatus of claim 21, wherein the image source module includes at least one of a receiver, transceiver, and transmitter.

23. The apparatus of claim 1, further comprising an input device configured to receive input data and to communicate the input data to the processor.

24. An apparatus comprising:
means for displaying image data including a plurality of image pixels, the displaying means including a plurality of display pixels configured to display a plurality of colors in a color space associated with the displaying means; and
means for processing the image data for display by the displaying means, the processing means configured for:
mapping the image data to the plurality of display pixels to provide data associated with each color plane in the color space associated with the displaying means, the color plane data including a color value for each display pixel in the displaying means;
for each color plane:
identifying display pixels having spatial frequencies below a threshold;
for each of the identified display pixels, calculating a dither visibility score based at least in part on comparison of the color value for the display pixel and a dither visibility function for the color plane, and
determining an accumulated dither visibility score for the color plane; and
applying temporal dither to a subset of the plurality of color planes based on the determined accumulated dither visibility scores.

25. The apparatus of claim 24, wherein the means for displaying image data includes a display device, or the means for processing includes a processor configured to communicate with the display device.

26. The apparatus of claim 24, wherein the processing means includes an accumulator.

27. The apparatus of claim 24, wherein the processing means includes a comparator.

28. A method for adaptively applying temporal dithering to display an input image having reduced dither visibility on a display device having a plurality of display pixels, each display pixel configured to display a plurality of colors in a color space associated with the display device, the method comprising:
mapping the input image to the plurality of display pixels to provide data associated with each color plane in the color space associated with the display device, the color plane data including a color value for each display pixel in the display device;
for each color plane:
identifying display pixels having spatial frequencies below a threshold;
calculating a dither visibility score for each of the identified pixels, wherein the dither visibility score is based at least in part on comparison of the color value for the display pixel and a dither visibility function for the color plane; and
determining an accumulated dither visibility score for the color plane; and
applying temporal dither to a subset of the plurality of color planes based on the determined accumulated dither visibility scores,
wherein the method is performed in its entirety by a physical computing device.

29. The method of claim 28, further comprising applying temporal dither to the color plane determined to have the highest accumulated dither visibility score.

30. The method of claim 29, further comprising applying temporal dither to the color plane determined to have the second-highest accumulated dither visibility score.

31. The method of claim 30, wherein the temporal dither applied to color plane determined to have the second-highest accumulated dither visibility score is lower than the temporal dither applied to color plane determined to have the highest accumulated dither visibility score.

32. A non-transitory computer storage medium comprising instructions that when executed by a processor cause the processor to perform a method for adaptively applying temporal dithering to display an input image having reduced dither visibility on a display device having a plurality of display pixels, each display pixel configured to display a plurality of colors in a color space associated with the display device, the method comprising:
mapping the input image to the plurality of display pixels to provide data associated with each color plane in the color space associated with the display device, the color plane data including a color value for each display pixel in the display device;
for each color plane:
identifying display pixels having spatial frequencies below a threshold;
calculating a dither visibility score for each of the identified pixels, wherein the dither visibility score is based at least in part on comparison of the color value for the display pixel and a dither visibility function for the color plane, and
determining an accumulated dither visibility score for the color plane; and
applying temporal dither to a subset of the plurality of color planes based on the determined accumulated dither visibility scores.

33. The non-transitory computer storage medium of claim 32, wherein the method further comprises applying temporal dither to the color plane determined to have the highest accumulated dither visibility score.

34. The non-transitory computer storage medium of claim 33, further comprising applying temporal dither to the color plane determined to have the second-highest accumulated dither visibility score.

35. The non-transitory computer storage medium of claim 34, wherein the temporal dither applied to color plane determined to have the second-highest accumulated dither visibility score is lower than the temporal dither applied to color plane determined to have the highest accumulated dither visibility score.
